(19) United States
(12) Patent Application Publication
(10) Pub. No.: US 2006/0079330 A1
(43) Pub. Date: Apr. 13, 2006

(54) Method and apparatus utilizing dynamic visual characters to address communications

(75) Inventors: Joseph L. Dvorak, Boca Raton, FL (US); Charles P. Schultz, Miami Beach, FL (US); James L. Tracy, Coral Springs, FL (US)

Correspondence Address: POSZ LAW GROUP, PLC, 12040 SOUTH LAKES DRIVE, SUITE 101, RESTON, VA, 20191, US

(73) Assignee: MOTOROLA, INC.

(21) Appl. No.: 10/964,253

(22) Filed: Oct. 13, 2004

(51) Int. Cl. G06F 19/00; G06F 17/00

(52) U.S. Cl. 463/42

(57) ABSTRACT

A communication device provides voice communications addressed to destinations corresponding to relevant characters in a game (117) in play. The communication device (101) provides, for example, a transmitter (105) for transmitting calls when operably connected to a dispatch network (111), and a processor (107). The processor is configured to facilitate interfacing with a user to play a multi-player game, in play between players including a first player on the communication device (101) and one or more second players having communication devices (103). The processor (101) is configured to facilitate, responsive to a call request, communicating via the transmitter with one or more recipients of a call from the first player, including automatically determining, in accordance with information representing the relevant characters, the appropriate recipient or recipients of the call, and causing the transmitter (105) to call the recipient or recipients. According to one or more embodiments, the communication is made via a dispatch network (111) responsive, for example, to a dispatch request.

### FIELD OF THE INVENTION

The present invention relates in general to wireless communication devices and networks, and more specifically to addressing voice communications using dynamic visual characters.

### BACKGROUND OF THE INVENTION

Multiple participant experiences where participants re portrayed by respective visual characters on a graphical user interface (GUI) are becoming more popular. For example, multiplayer games provide a very popular type of electronic entertainment. A multiplayer game may be played between any number of players, from two to many thousands. Examples of multiplayer games are provided by an adventure set in a virtual world, a role playing game, video games, and other group electronic games and puzzles.

Typically in a multiple participant environment all participants are represented and presented as respective characters on a GUI. For example, a player is represented by a character when playing the game. The multiplayer game tracks information regarding the characters. A character typically interacts with other relevant characters, as determined by the multi-participant environment, e.g. game. For example, a character opposing or cooperating with another character in close proximity performs selected actions directed to one or more other character, for example “shoot”, and such actions may not affect remaining characters. On the other hand, at times the character is part of a group of other characters that may be acting in association. As the game progresses, the characters that are relevant to a particular player may change.

While playing the multiplayer game, a player may want to direct voice communications to one or more relevant characters. Unfortunately, in conventional multiplayer games, the player may need to interrupt play or suspend the game, in order to interact with the system to designate the recipient of the voice communication.

Conventional communication in a multiplayer game prohibits the player from engaging in voice communication with a specific individual without interrupting the flow of the game. Moreover, this failing negatively impacts the quality of the gaming experience.

Therefore, to address the above described problems and other problems, what is needed is a method and apparatus for permitting communication to specific participants amongst participants in a multi-participant environment without interrupting the flow of the environment.

### BRIEF DESCRIPTION OF THE DRAWINGS

The accompanying figures, where like reference numerals refer to identical or functionally similar elements and which together with the detailed description below are incorporated in and form part of the specification, serve to further illustrate a preferred embodiment and to explain various principles and advantages in accordance with the present invention.

FIG. 1 is a diagram illustrating a simplified and representative environment associated with a communication device and exemplary wireless networks utilizing game characters to address communications, in accordance with various exemplary embodiments;

FIG. 2 is a diagram illustrating a simplified and representative environment associated with a communication device and exemplary wireless networks utilizing game characters to address communications, arranged for use with one or more game consoles and optional game servers, in accordance with various exemplary embodiments;

FIG. 3 is a diagram illustrating a simplified and representative environment associated with a communication device and exemplary direct connect environment utilizing game characters to address communications, arranged for use with a game console and optional game server, in accordance with various exemplary embodiments;

FIG. 4 is a flow chart illustrating an exemplary procedure for communicating with other players, in accordance with various exemplary and alternative exemplary embodiments;

FIG. 5 is a flow chart illustrating an exemplary procedure for determining identifiers corresponding to call recipients, in accordance with various exemplary and alternative exemplary embodiments;

FIG. 6 is a flow chart illustrating an exemplary procedure for handling a gaming communication, in accordance with various exemplary and alternative exemplary embodiments;

FIG. 7 is a flow chart illustrating an exemplary procedure for determining call identifiers and optional priority processing of a call for a game in play, according to one or more exemplary embodiments; and

FIG. 8 is a block diagram of an exemplary communication device for use in operation of one or more embodiments.

### DETAILED DESCRIPTION OF THE PREFERRED EMBODIMENTS

In overview, the present disclosure concerns wireless communications devices or units, often referred to as communication devices, such as cellular phone, two-way radios, and the like having capability to operate in a multi-participant environment or experience, such as game operating capability, where game operating capability includes capability to play a game, and/or an ability to communicate with or control a game device, for example via short range radio, ultra wide band radio, Bluetooth, IEEE 802.11 wireless fidelity (Wi-Fi), direct connection, etc. The communication devices can be associated with a communication system such as a local area network, an Enterprise Network, a cellular Radio Access Network, or the like. Such communication systems may further provide services such as voice and data communications services. More particularly, various inventive concepts and principles are embodied in systems, communication devices, and methods therein for use in connection with participating in the corresponding environment, e.g. playing a multiplayer game in association with communication over a communication device.

It should be noted that the term communication device may be used interchangeably herein with subscriber unit, wireless subscriber unit, wireless subscriber device, non-subscriber device, message switching device or the like. Each of these terms denotes a device ordinarily associated with a user and/or typically a wireless mobile device that may be used with a public network, for example in accordance with a service agreement, or within a private network such as an enterprise network. Some examples of such units include personal digital assistants, personal assignment pads, game controllers, personal computers, cellular handsets, two-way radios, and/or equivalents thereof, equipped or adapted for game play or the like in addition to voice or data communication.

The instant disclosure is provided to further explain in an enabling fashion the best modes of performing one or more embodiments of the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms such as first and second, and the like, if any, are used solely to distinguish one from another entity, item, or action without necessarily requiring or implying any actual such relationship or order between such entities, items or actions.

Much of the inventive functionality and many of the inventive principles when implemented, may be supported with or in software or integrated circuits (ICs), such as a conventional or digital signal processor and software therefore or application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions or ICs with minimal experimentation. Therefore, in the interest of brevity and minimization of any risk of obscuring the principles and concepts according to the present invention, further discussion of such software and ICs, if any, will be limited to the essentials with respect to the principles and concepts used by the exemplary embodiments.

The communication systems and communication devices of particular interest are those providing or facilitating voice communications services or data or messaging services over cellular wide area networks (WANs), such as conventional two way systems and devices, various cellular phone systems including analog and digital cellular, CDMA (code division multiple access) and variants thereof, GSM (global system for mobile communications), GPRS (General Packet Radio System), 2.5G and 3G systems such as UMTS (Universal Mobile Telecommunication Service) systems, Internet Protocol (IP) Wireless Wide Area Networks like 802.16, 802.20 or Flarion, integrated digital enhanced networks and variants or evolutions thereof. Furthermore the wireless communication units or devices of interest can have short range wireless communications capability normally referred to as WLAN capabilities, such as IEEE 802.11, Bluetooth, or Hiper-Lan and the like optionally using CDMA, frequency hopping, OFDM or TDMA access technologies and one or more of various networking protocols, such as TCP/IP (Transmission Control Protocol/Internet Protocol), UDP/UP (Universal Datagram Protocol/Universal Protocol), IPX/SPX (Inter-Packet Exchange/Sequential Packet Exchange), Net BIOS (Network Basic Input Output System) or other protocol structures. Alternatively the wireless communication units or devices of interest may be connected to a LAN using protocols such as TCP/IP, UDP/UP, IPX/SPX, or Net BIOS via a hardwired interface such as a cable and/or a connector.

As further discussed herein below, various inventive principles and combinations thereof are advantageously employed to permit voice communication amongst participants in a multi-participant or user environment or experience, e.g. players in a multiplayer game while substantially allowing the flow of the experience or game to continue. While much of the remaining discussion will be in the context of a multiplayer gaming environment or experience it will be appreciated that the concepts and principles described apply equally to other multi-participant experiences or environments where other participants are portrayed as characters on a graphical user interface, e.g. visual display. Examples of such multi-participant experiences or environments include situations such as may be encountered in visual models of real life activities or systems, such as air traffic control or perhaps a battlefield situation showing locations and changes in location of friends and foes.

A mechanism is provided whereby voice communications can be directed to characters in the game that are relevant to the player's character, improving latency that can be experienced over, for example, a data channel.

In overview, when players begin playing a multiplayer game, the players are associated with characters or gaming characters that can be displayed via the game, for example, on a display device. Information for players that are associated with the characters (referred to hereinafter variously as identifier, recipient identifier, caller identifier) is not necessarily known to the other players. According to one or more embodiments, information associated with a character may include a call identifier, e.g. a phone number or address that can be used to communicate between players. While playing the game, a particular player can begin a communication, for example via a communication switch (e.g., a communication or push to talk button), a voice command, or otherwise initiate/arrange a communication link, such as a voice over internet protocol link or the like. The game has information including the character(s) currently relevant to the particular player. For example, a game can provide a visual indication of the relevant characters. The call identifier(s) can be obtained for the relevant character(s). The communication can utilize the call identifier in order to call the correct relevant player(s). Note that additional information, such as player identity or status may be associated with a character. This may include network status and capabilities of the player as well as call or communication status or rules, e.g. in a call, not call capable, not allowing calls from certain players, etc. This information can be provided, for example, in a relevant database via a provisioning activity or tracking ongoing status.

According to exemplary and alternative embodiments, call identifiers may be stored in association with characters; call identifiers may be stored in association with character data such as, e.g., a name, and character data may be associated with call identifiers. Also, the call identifiers and character data information can be distributed, for example, among the communication device, the game console, a game server, and/or fixed network equipment.

Further in accordance with exemplary and alternative embodiments, various illustrations of embodiments will be discussed and described.

FIG. 1 is a diagram illustrating a simplified and representative environment associated with a communication device 101 and exemplary wireless networks 111 utilizing game characters to address communications, in accordance with various exemplary embodiments. In the illustrated embodiment, the user of a communication device 101 is playing a multiplayer game 117 on the communication device 101, in connection with a network, such as a dispatch network. In this example, the communication device 101 can include a transmitter 105, a processor 107, and a game interface 115 all intercoupled as is known. The user can indicate a call request in order to initiate a communication, for example, by depressing a call request button, e.g. a push to talk button, or by speaking in a voice operated transmit (VOX) mode.

The game can provide the identifier(s), such as a name (for an individual) or a group identifier (for a group), corresponding to the character(s) that are relevant to the player's character. A dispatch request, for example, can be transmitted by the communication device 101 to the dispatch network, here represented by fixed network equipment (FNE) (tower) 111.

The dispatch request can be, for example a conventional request including the name or group identifier. Alternative embodiments provide for identification of communications associated with a game. Alternative embodiments support non-dispatch type communications.

The network, if involved in the call, receives the call, for example, the dispatch request, including the identifier, and can obtain a call identifier corresponding to the identifier, for example by accessing a subscriber database 113. When the call identifier is obtained, receivers 109 at communication devices 103 for the players associated with the relevant characters can be connected. The illustrated embodiment shows a dispatch group call involving two recipient communication devices 103. Alternative embodiments may involve one recipient communication device, or two or more recipient communication devices.

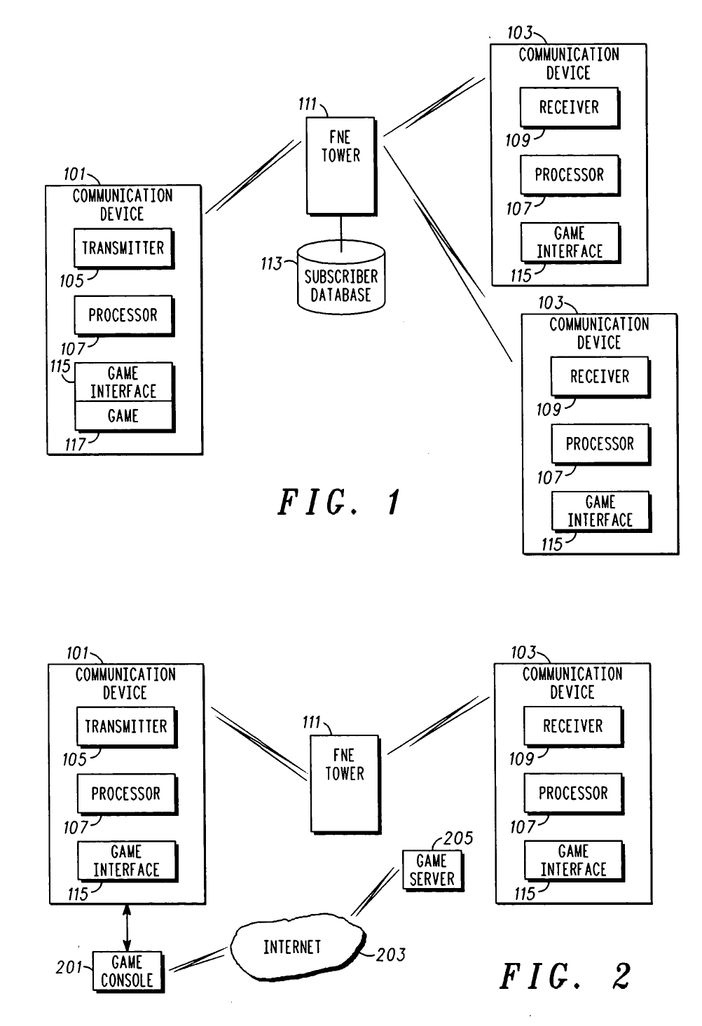

FIG. 2 is a diagram illustrating a simplified and representative environment associated with a communication device 101 and exemplary wireless networks utilizing game characters to address communications, where the communication device 101 is arranged for use with a game console and optional game server, in accordance with various exemplary embodiments. In the illustrated embodiment, the user of the communication device 101 is playing a multiplayer game on a game console 201. The communication device 101 can be connected to the game console 201 via the game interface 115 or portion thereof, and the communication device 101 may be in communication with a dispatch network.

The user can indicate a call request in order to initiate a communication, for example as previously described. The communication device 101 may interact with the game console 201 via the game interface 115, to request that the game console provide the identifier(s), such as a name (for an individual) and/or a group identifier (for a group), corresponding to the character(s) that are relevant to the player's character. According to one or more embodiments, information regarding the characters in the multiplayer game and/or the information for obtaining the call identifier can be distributed among, for example, the game, the game console 201 and/or the game server 205, or any combination of the foregoing. According to one or more embodiments, the game server can be accessed over a network, for example a wide area network, such as the Internet 203, via a wired or wireless local area network (not specifically illustrated), and/or another wide area network (not specifically illustrated). Optionally, the communication device 101 can interact with the game server 205. In the illustrated embodiment, the game console 201 can obtain the call identifier from the game server 205 via the internet 203, and can provide the call identifier to the communication device 101 via the game interface 115. For example the game server may have call identifiers corresponding to identifiers for participants or players in the game. In alternative embodiments, the calling information can reside in the communication device.

Upon receipt of the call identifier, a dispatch request can be transmitted by the communication device 101 to the dispatch network, here represented by fixed network equipment (FNE) (tower) 111. The dispatch network receives the dispatch request including the call identifier, and can connect the call to the communication device 103. The exemplary embodiment illustrates a dispatch call involving one recipient communication device 103, although alternative embodiments may involve two or more recipient communication devices.

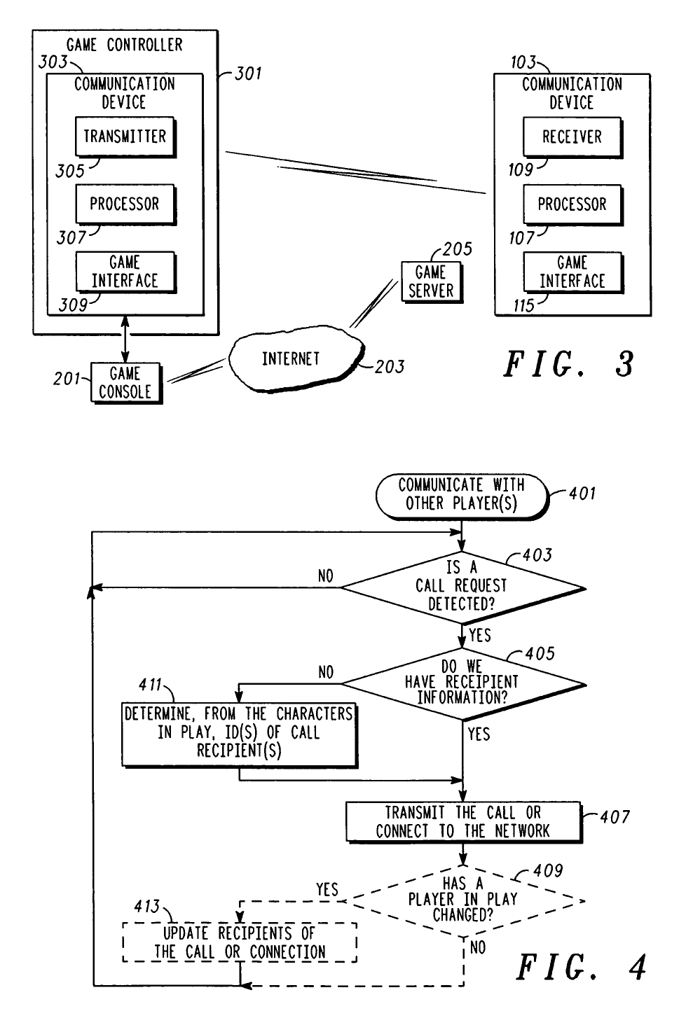

FIG. 3 is a diagram illustrating a simplified and representative environment associated with a communication device in an exemplary direct connect environment utilizing game characters to address communications. The device is arranged for use with a game console and optional game server, in accordance with various exemplary embodiments. In the illustrated embodiment, a communication device 303 can be included in or as part of a game controller 301. The communication device 303 can include, for example, a transmitter 305 and a processor 307. The communication device 303 can be connected to the game console 201 via a game interface 309, and the communication device 303 can communicate with other communications devices 103.

The user can indicate a call request in order to initiate a communication, for example by voice command received at the communication device 303, or for example via a switch on the game controller 301 or communication device. The communication device 303 can interact with the game console 201 via the game interface 115, as described for example in connection with FIG. 2. In the interest of clarity, details addressed previously in connection with an earlier figure are here omitted.

When the call identifier is obtained, a direct connect call can be transmitted by the communication device 303, with the call identifier, and thus connect directly (i.e. device to device) to the other player's communication device 103. The respective players can communicate via the direct connect communication.

FIG. 4 is a flow chart illustrating an exemplary procedure for communicating with other players 401 in accordance with various exemplary and alternative exemplary embodiments. This process can be advantageously implemented by a communication device, such as discussed above or similar devices with appropriate functionality as herein described. The process determines whether it detects a call request 403, such as a voice command, manual indication, etc. When there is no call request detected 403, the process can loop back on itself. If a call request is detected, then it is determined whether recipient information is available 405, such as from a previous call. If the recipient information is not available 405, then the process can determine, from the current character or characters in play, identifier(s) corresponding to the character or characters and hence can identify appropriate call recipients 411. If the characters are part of a group, the corresponding group call identifier can be determined. At 407, the process transmits the call or connects to the network, as appropriate for the type of communication with which an underlying apparatus or communication device is adapted to operate. Optionally, at 413 the process can dynamically update identifiers if there is a change to the relevant characters as determined at 409. For example, if a new character(s) becomes relevant, or other character(s) become irrelevant. Processing can loop to determine whether another call request is detected 403.

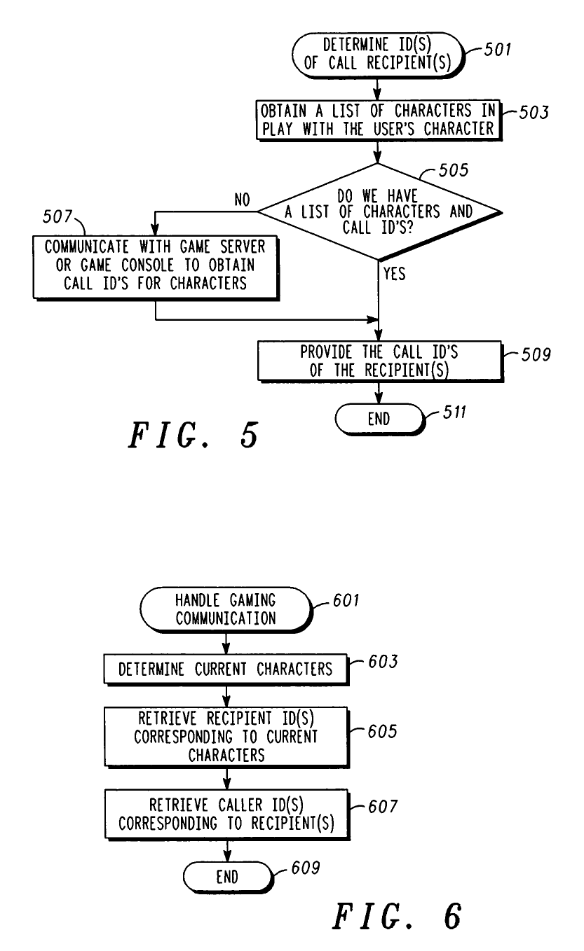

FIG. 5 is a flow chart illustrating an exemplary procedure for determining identifiers corresponding to call recipients 501, in accordance with various exemplary and alternative exemplary embodiments. According to various exemplary embodiments, the illustrated functions can be implemented in, for example, the communication device, the game console, the game server, and/or can be distributed among one or more of the foregoing. The process can obtain a list of relevant characters, e.g., those characters currently in play with the user's character 503. At 505, the process can determine whether it has an available list of characters and corresponding call identifiers. Although it may be convenient to maintain a list of current characters in play and corresponding call identifiers, some embodiments can provide that call identifiers corresponding to relevant characters can be obtained by communicating with the game server and/or game console 507. At 509, the process can provide the call identifiers for the recipients of the communication.

According to alternative exemplary embodiments, the communication unit may maintain, e.g., names of players and call identifiers sufficient for communicating. Hence, obtaining, from the game, a list of player names for relevant characters can be sufficient for the communication device to determine corresponding call identifiers. For example, a given communication unit can subscribe to messages from the game server where the messages include, for example player status and affiliation information that changes during the course of the game.

FIG. 6 is a flow chart illustrating an exemplary procedure for handling a gaming communication 601, in accordance with various exemplary and alternative exemplary embodiments. The illustrated procedure may be implemented, for example, in a game, on a game console, or as a process or interface incorporated with a game.

Upon receipt of a gaming communication intended for certain recipients that are also participants in the game the process operates to determine appropriate identifiers and call identifiers for such recipients. This begins by determining those characters which are currently relevant 603, e.g. characters that are participating in a game. Determining relevant characters can be conveniently implemented in accordance with known procedures. The process can then retrieve identifiers (names, group names, or other identity information) corresponding to the currently relevant characters 605. It may be convenient to utilize available lists of characters and corresponding information maintained by the process, or in other acceptable manners. For example a recipient for the communication can be specified by the originator or user of the originating device or can be determined by detecting a context of the game in play, including selecting one or more other players or participants that are opposing or cooperating with a first player in play where the first player is the initiator or originator for the communication. Utilizing the identifiers, the process can then retrieve call identifiers corresponding to the identifiers 607. Processing ends at 609.

If the information regarding characters is associated with call identifiers, then call identifiers can be obtained based on the currently relevant characters.

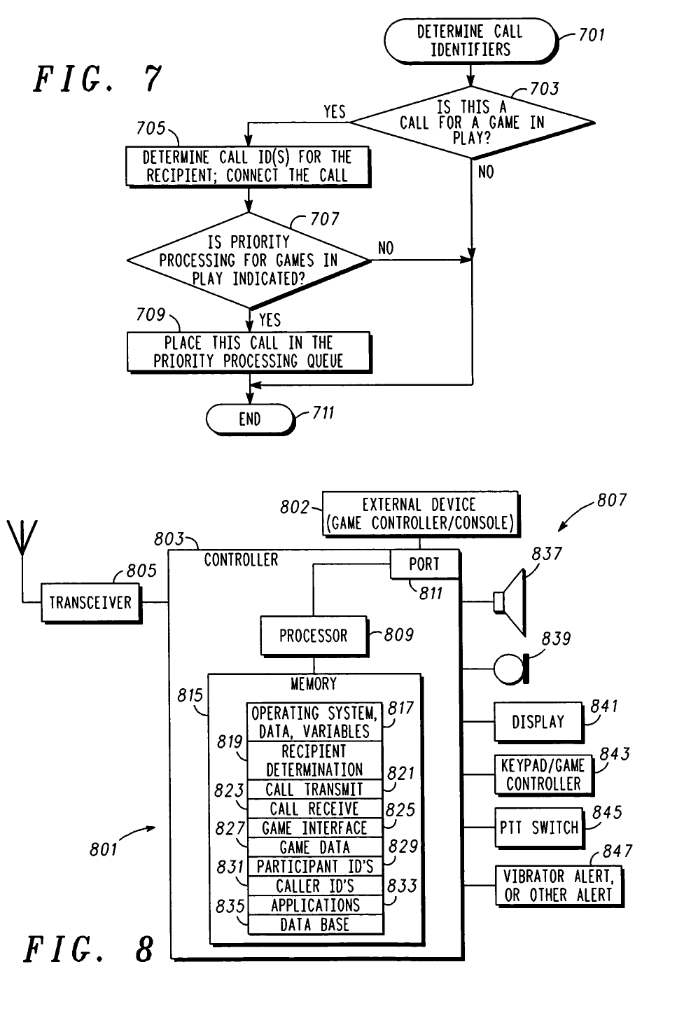

FIG. 7 depicts a flow chart illustrating an exemplary procedure for determining call identifiers 701 and optional priority processing of a call for a game in play, according to one or more exemplary embodiments. The illustrated processing may advantageously and conveniently be embodied in fixed network equipment used in connection with networked communications. The discussion below will utilize fixed network equipment as a reference embodiment, however it is understood that other apparatus may also be used to practice the methods described.

According to one or more embodiments, the fixed network equipment can determine that a call it received is for a game in play 703. This can be determined, for example, by an indicator embedded in the call, or by a particular call command. If the call is for a game in play, then the fixed network equipment can determine and provide the call identifier corresponding to the recipient identified in the call 705.

Optionally, the fixed network equipment may be arranged so as to provide priority to calls relating to games currently in play. This can increase the speed of communication amongst players in a game. Accordingly, the fixed network equipment can determine whether priority processing is indicated for games in play 707. Priority processing can be indicated, for example, by a system-wide indicator, a local indicator, and/or an indicator embedded in the call. If priority processing is indicated, then at 709 the fixed network equipment can place the call in the priority queue for priority processing, or perform other processing appropriate to achieving priority handling for the call.

FIG. 8 is a block diagram of an exemplary communication device 801 for use in operation of one or more embodiments. The communication device 801 may be coupled to an external device 802 such as a game controller or game console as noted above. The communication device 801 includes a controller 803, a transceiver 805, and a user interface 807 intercoupled as depicted and generally known. The controller 803 includes a processor 809, a communication port 811, and a memory 815 intercoupled as shown.

The transceiver is generally known and widely available and will vary with system air interface protocols and the like. The communication port 811 is for communication with the external device 802 including devices available through a local or wide area network. The processor 809 may comprise one or more microprocessors and/or one or more digital signal processors. The memory 815 is coupled to the processor 809 and can comprise, for example, one or more of a read-only memory (ROM), a random-access memory (RAM), a programmable ROM (PROM), an electrically erasable read-only memory (EEPROM), SIM card, magnetic memory and/or the like. The memory includes various software or firmware programs that when executed by the processor results in the controller 803 or processor 809 interacting with and controlling the transceiver 805 and user interface 807 and in some embodiments communicating with the external device via the port 811 in order to provide appropriate services (communications, gaming, etc.) to a user of the communication device.

The memory 815 includes multiple memory locations for storing programs (including requisite data) executed by the processor 809. These include, inter alia, an operating system, data and variables 817 for handling basic operations, computer programs for causing the processor to facilitate various functions such as a recipient determination 819 (call identifiers), call transmit 821, call receive 823, and a game interface 825. Additionally depicted is a game data database 827, participant identifiers 829, call identifiers 831 that can be available in some embodiments of the communication device as well as various other subroutines and applications 833 and databases 835 that may be available and required as will be recognized by one of ordinary skill. The computer programs may be stored, for example, in ROM or PROM and may direct the processor 809 in controlling the operation of the controller 803 and the balance of the communication device 801 as will be further described below.

The user interface 807 includes an earpiece or speaker 837, a microphone 839, a display 841 for presenting device operational information and in some embodiments visual data corresponding to a game, a user input device 843, such as a keypad that may operate as a game controller in some embodiments, a Push to Talk switch 845 for initiating a call request, in some embodiments an alerting device 847 for providing, for example, a vibratory alert or other alert when a call is received or to indicate other status information and in some embodiments a camera (not shown). A headset (not shown) may incorporate the speaker and microphone. The user input device 843 may comprise one or more of various known input devices, such as a keypad, a computer mouse, a touchpad, a touch screen, a trackball, game pad, joystick, wheel controller, dance mat, a keyboard and/or the like. These elements are generally known and widely available.

The processor 809 can be programmed to detect a request from the user to make a call or otherwise to send a communication, for example, by receipt of voice input on the microphone 839 via a VOX function or by user manipulation of the PTT switch 847. The controller 803 may alert the user of the device, for example of the receipt of a call, by way of the speaker 837 or alerting device 847. The user may invoke functions accessible through the user input device 843.

Responsive to signaling from the user input device 843, in accordance with instructions stored in memory 815, or automatically upon receipt of certain information via the transceiver 805, the processor 809 may direct the stored information or received information, such as directing a communication or call, to the speaker 811. The display may present information to the user by way of a conventional liquid crystal display (LCD) or other visual display.

The relevant part of the multi-player game may be downloaded to the communication device, for example over the port 811 or via the transceiver 805. The game may be played on the communication device in connection with a stand-alone configuration. According to one or more embodiments, a portion of the game is provided on an external device, for example a game console, and the communication device can be connected to or can communicate with the game console and optionally can act as a controller for the game console. According to alternative and/or exemplary embodiments, the communication device is configured as or embedded into a game controller, and the keypad can include buttons for controlling the game.

The communication device is arranged to facilitate wireless communications between players of a multi-player game while the game is ongoing or in play. Generally this suggests that a particular game character or game entity be identified or selected, e.g. graphically or visually identified or selected, as one that the user, also a participant in the game, wishes to communicate with. A call identifier that corresponds to the game character is then determined. This may necessitate first determining an identifier(s) or recipient(s) identifier(s), e.g. names or group names for example, and then via a cross referenced database, corresponding call identifiers, e.g. addresses, phone numbers, or the like for the identifier(s). Given the call identifier(s) appropriate communication links via for example, the transceiver 805 can be established with one or more of the other participants or players in known manners.

Thus in one embodiment of the communication device 801 a game is being played using the controller 803 and user interface 807, where this game software is included at least in part in the memory 815 as part of the game interface 825 and game data 827. Responsive to a call request (activation of PTT switch 845), the processor facilitates determination of a game character via status of the user input or keypad 843 or location of game character on the display or from the game data 827 and the corresponding participant identifier is selected from the participant ID database 829 using the recipient determination routines. This is further cross referenced to the call identifiers data 831 to select or determine an address or phone number for the particular participant. Note that call identifiers for a participant or group can also be retrieved from a database associated, for example, with the game server or the like. Given the call identifier the call transmit 821 and call receive routines 823 can be used by the processor 809 or controller 803 to control the transceiver 805 to establish a communication or call with the particular participant in accordance with known techniques that may be specific to a particular communication network.

This disclosure is intended to explain how to fashion and use various embodiments in accordance with the invention rather than to limit the true, intended, and fair scope and spirit thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. A communication device comprising:
a transmitter for transmitting calls when operably connected to a communication network; and
a processor, coupled to the transmitter, wherein the processor is configured to facilitate interfacing with a user to play a multi-player game, in play between a plurality of players including a first player and one or more second players; and
the processor further being configured to facilitate, responsive to a call request, communicating via the transmitter with at least one recipient of a call from the first player, including (i) automatically determining, responsive to information representing the plurality of players in play, the at least one recipient to be at least one of the second players, and (ii) causing the transmitter to call the at least one recipient.

2. The communication device of claim 1, wherein the transmitter is connected to the dispatch network responsive to the call request.

3. The communication device of claim 1, wherein the call request is one of a voice command received on a microphone connected to the processor, and a call request received on a manual switch operably connected to the processor.

4. The communication device of claim 1, wherein a push to talk provides the call request and the at least one recipient corresponds to a graphical selection.

5. The communication device of claim 1, wherein the processor is further configured to facilitate determining a call identifier of the at least one recipient, and to facilitate opening a channel from the transmitter to the at least one recipient by passing the call identifier to the transmitter.

6. The communication device of claim 1, wherein the processor is further configured to facilitate obtaining a call identifier corresponding to the at least one recipient by communicating with a game server or a game device, and to facilitate utilizing the call identifier in the call.

7. The communication device of claim 1, wherein the processor stores a list of players in the game and corresponding call identifiers, and wherein the processor is further configured to facilitate determining a call identifier corresponding to the at least one recipient from the list.

8. The communication device of claim 1, wherein the at least one recipient is further determined by detecting a context of the game in play, including selecting one or more of the second players when opposing or cooperating with the first player in play.

9. The communication device of claim 1, wherein the processor is further configured to change the at least one recipient, responsive to a change of player in the one or more second players.

10. The communication device of claim 1, wherein the information representing the plurality of players in play comprises visual elements in the game.

11. A game device comprising:
a communication interface for receiving and transmitting communications when operably connected to a communication device; and
a processor, coupled to the communication interface, wherein the processor is configured to facilitate processing a multi-player game in play between a plurality of players including a first player and one or more of the second players;
the processor further being configured to facilitate, responsive to a request from the communication interface, determining at least one recipient of a call from the first player including automatically determining, responsive to information representing the plurality of players in play, the at least one recipient to be one or more of the second players.

12. The game device of claim 11, wherein the processor is further configured to facilitate determining a call identifier corresponding to the at least one recipient responsive to a request therefore, to facilitate utilizing the call identifier in the call.

13. The game device of claim 12, wherein the processor is further configured to facilitate obtaining the call identifier by communicating with a game server.

14. The game device of claim 12, wherein the processor is configured to facilitate storing a list of players in the game and corresponding call identifiers, and determining the call identifier corresponding to the at least one recipient from the list.

15. The game device of claim 11, wherein the at least one recipient is further determined by detecting a context of the game in play, including selecting one or more of the second players when opposing or cooperating with the first player in play.

16. The game device of claim 11, wherein the processor is further configured to change the at least one recipient, responsive to a change of player in the one or more second players.

17. The game device of claim 11, the processor being configured to facilitate communicating with one or more communication devices.

18. A controller for a communication messaging system, the controller comprising:
a communication interface for receiving and transmitting calls, including at least one call from a caller intended for at least one recipient in a game play; and
a processor, coupled to the communication interface, configured to facilitate receiving the at least one call via the communication interface; detecting whether the call is for a game in play; and if so, at least one of: (i) determining a call identifier from the recipient identifier and connecting the caller to the at least one recipient; and (ii) processing the call at a higher priority than other calls.

19. The controller of claim 18, wherein the call identifier is obtained by at least one of (i) communicating with a game server, and (ii) determining, from a list of players in the game and corresponding call identifiers, the call identifier corresponding to the at least one recipient from the list.

20. A method for providing game play with automatic addressing of a call, comprising:
(A) determining, in a game device processing a multi-player game in play between a plurality of players including a first player and one or more second players, responsive to a call request, at least one recipient of a call from the first player, wherein the at least one recipient is determined responsive to visual elements in the game representative of the one or more second players;
(B) causing a communication interface operably connected to the game device to open a dispatch channel to the at least one recipient, responsive to the determining.

21. The method of claim 20, wherein the at least one recipient is determined by detecting a context of the game in play, including selecting one or more of the second players when opposing or cooperating with the first player in play.

22. The method of claim 20 wherein the dispatch channel is independent of a game channel used for game data.
